(19) United States
(12) Patent Application Publication
(10) Pub. No.: US 2014/0123491 A1
(43) Pub. Date: May 8, 2014

(54) FAN IMPELLER BALANCE CALIBRATING METHOD

(71) Applicant: ASIA VITAL COMPONENTS CO., LTD., New Taipei City (TW)

(72) Inventor: Bor-Bin Tsai, New Taipei City (TW)

(73) Assignee: ASIA VITAL COMPONENTS CO., LTD., New Taipei City (TW)

(21) Appl. No.: 13/670,461

(22) Filed: Nov. 7, 2012

(51) Int. Cl. G01P 15/18

(52) U.S. Cl. CPC G01P 15/18
USPC 29/889

(57) ABSTRACT

A fan impeller balance calibrating method includes steps of: placing a fan impeller onto a balance measurement unit and activating the fan impeller to rotate; using a detector of the balance measurement unit to detect the amount of unbalance and phase of the fan impeller in rotation and generate a detection signal according to the amount of unbalance and phase of the fan impeller; and providing a counterweighing unit, which receives the detection signal to find at least one hole of the fan impeller according to the detection signal, which is to be counterweighed and counterweighs the hole with a counterweight. By means of the fan impeller balance calibrating method, the measurement and counterweighing of the fan impeller are automated. Therefore, the working time is shortened and the manufacturing cost is lowered.

### BACKGROUND OF THE INVENTION

1. Field of the Invention

The present invention relates generally to a fan impeller balance calibrating method, and more particularly to a fan impeller balance calibrating method in which the degree of balance of the fan impeller is automatically adjusted to shorten the working time and lower the manufacturing cost.

2. Description of the Related Art

Along with the rapid development of high-tech industries, the functions of various electronic products have become more and more powerful. As a result, the electronic components inbuilt in the electronic products generate a great amount of waste heat in operation. In general, it is necessary to dispose a heat sink or a radiating fin assembly on the electronic component to increase heat dissipation area for enhancing heat dissipation effect. However, the heat sink or radiating fin assembly can dissipate the heat only by means of radiation so that the heat dissipation effect is limited. Therefore, it is necessary to additionally dispose a cooling fan to carry away the heat of the heat sink or radiating fin assembly so as to enhance the heat dissipation performance. Accordingly, the cooling fan is a very important component of the thermal module. However, in operation, the cooling fan often makes loud noise or severely vibrates due to some external factors or the affection of its own structural design. In this case, the working stability of the electronic component (such as the hard disk) will be affected. Therefore, in manufacturing, it is necessary to calibrate the balance of the fan impeller to increase the ratio of good products.

In dynamic balance test of the conventional fan impeller, with respect to an unbalanced fan impeller, balance earth is manually added to the hub or inner side or bottom side of the fan impeller and then the dynamic balance test of the fan impeller is again performed to increase or decrease the amount of the balance earth. Such balance test process is repeatedly performed until the balance of the fan impeller is calibrated and the fan impeller is completely balanced.

By means of the above method, the balance of the fan impeller can be achieved. However, in the test, it is necessary to manually add the balance earth to the fan impeller or remove the balance earth from the fan impeller. Such process is laborious, time-consuming and complicated. Moreover, the balance earth is manually added to the fan impeller or removed from the fan impeller. This is likely to cause error of weight. As a result, the achieved degree of balance is poor. According to the above, the conventional technique has the following shortcomings:
1. The conventional fan impeller balance calibrating method is laborious and time-consuming.
2. The conventional fan impeller balance calibrating method is complicated.
3. Error of weight is often takes place in the conventional fan impeller balance calibrating method.
4. The degree of balance achieved by the fan impeller balance calibrating method is poor.

### SUMMARY OF THE INVENTION

It is therefore a primary object of the present invention to provide a fan impeller balance calibrating method in which the degree of balance of the fan impeller is automatically adjusted.

It is a further object of the present invention to provide the above fan impeller balance calibrating method, which can shorten the working time and lower the manufacturing cost of the fan impeller.

It is still a further object of the present invention to provide the above fan impeller balance calibrating method, which can achieve better degree of balance.

It is still a further object of the present invention to provide the above fan impeller balance calibrating method, which can increase the operation efficiency of the fan.

To achieve the above and other objects, the fan impeller balance calibrating method of the present invention is applied to a balance calibrating device having a balance measurement unit. The fan impeller balance calibrating method includes steps of:
placing a fan impeller with multiple holes onto a calibrating platform of the balance measurement unit and activating the fan impeller to rotate;
using at least one detector of the balance measurement unit to detect the amount of unbalance and phase of the fan impeller in rotation and generate a detection signal according to the amount of unbalance and phase of the fan impeller; and
providing a counterweighing unit, the counterweighing unit serving to receive the detection signal to find at least one hole of the fan impeller according to the detection signal, which is to be counterweighed, the counterweighing unit then counterweighing the hole with a counterweight and determining the weight of the counterweight.

In manufacturing of the fan impeller, the measurement and counterweighing of the fan impeller are automated. Accordingly, the fan impeller can have better degree of balance. Moreover, the working time is shortened and the manufacturing cost is lowered. Also, the operation efficiency of the fan is increased.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart of a first embodiment of the fan impeller balance calibrating method of the present invention;

FIG. 2A is a perspective view showing that a fan impeller to be calibrated is placed on a balance calibration device of the first embodiment of the fan impeller balance calibrating method of the present invention;

FIG. 2B is a bottom perspective view of the fan impeller;

FIG. 2C is a perspective view showing the operation of the balance calibration device of the first embodiment of the fan impeller balance calibrating method of the present invention;

FIG. 2D is a sectional view showing the operation of the balance calibration device of the first embodiment of the fan impeller balance calibrating method of the present invention;

FIG. 3A is a perspective view showing the operation of the balance calibration device of a second embodiment of the fan impeller balance calibrating method of the present invention;

FIG. 3B is a top perspective view of a fan impeller to be calibrated; and

FIG. 4 is a perspective view showing the operation of the balance calibration device of a third embodiment of the fan impeller balance calibrating method of the present invention.

### DETAILED DESCRIPTION OF THE PREFERRED EMBODIMENTS

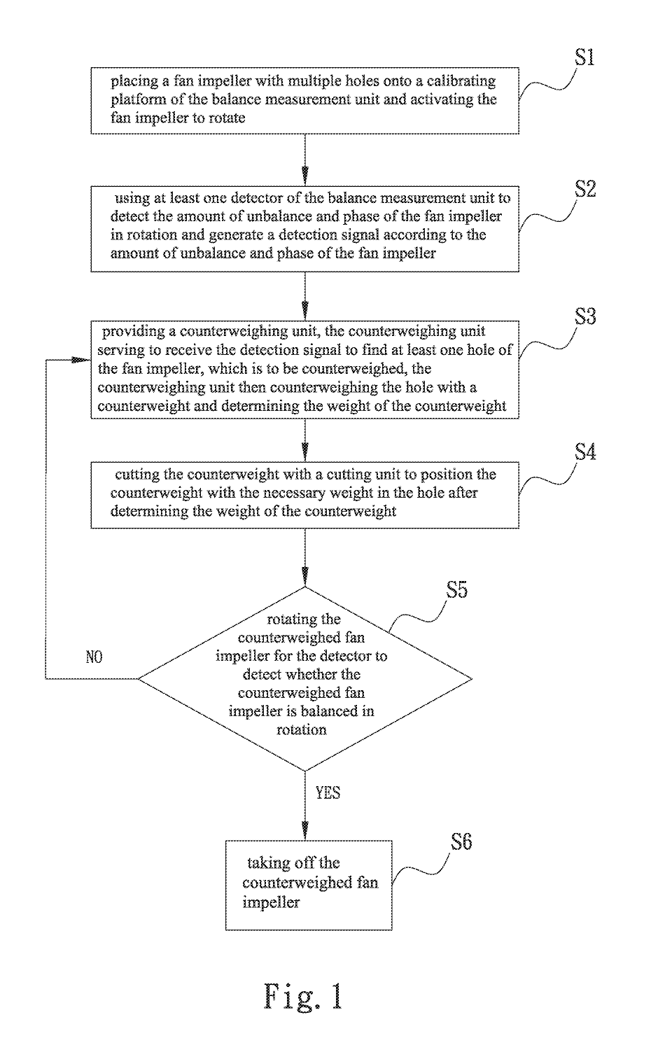

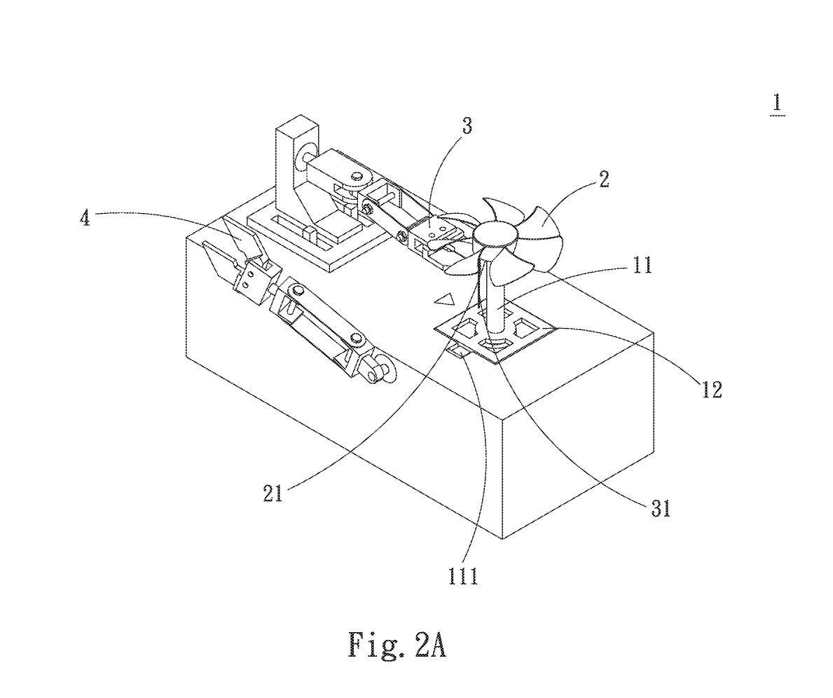

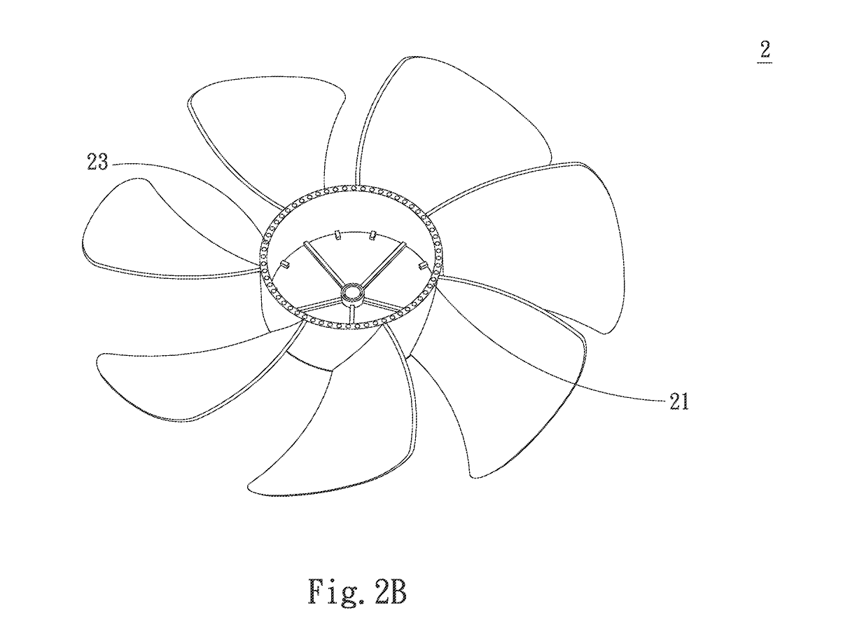

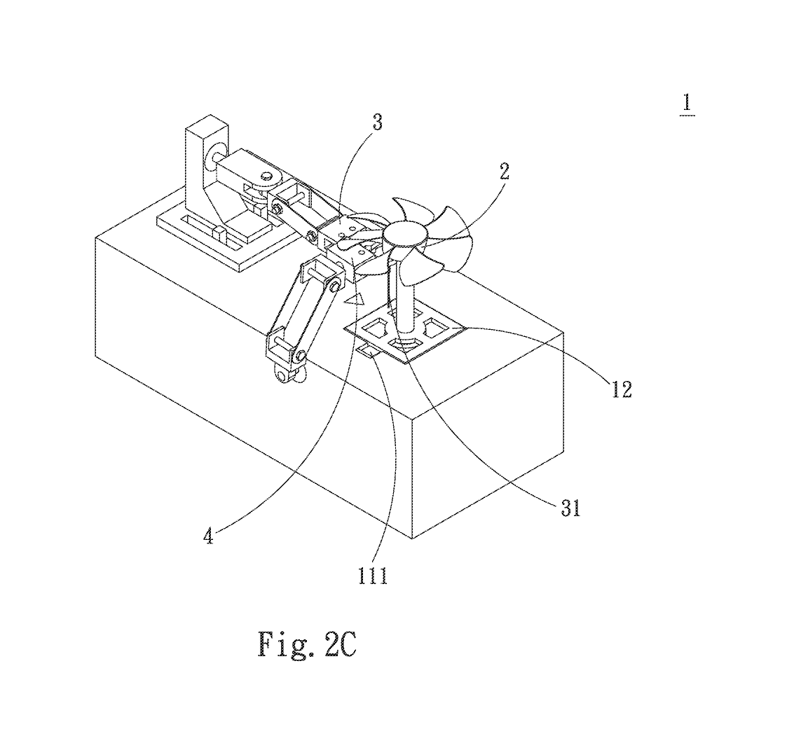

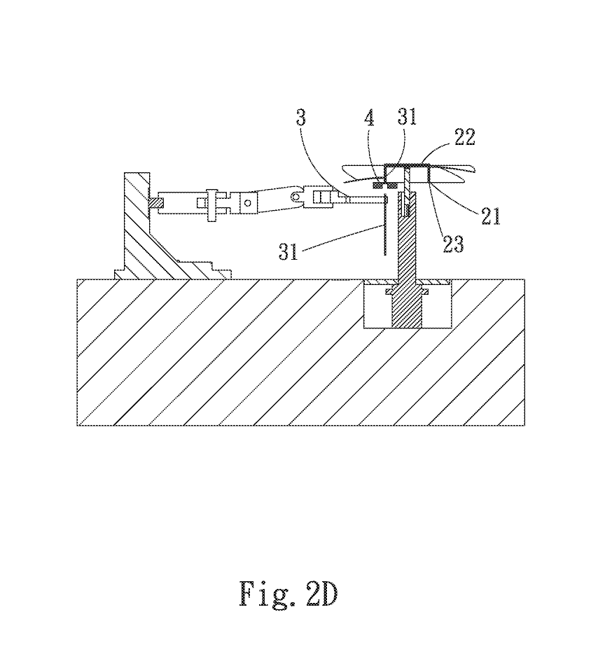

Please refer to FIGS. 1 and 2A to 2D. FIG. 1 is a flow chart of a first embodiment of the fan impeller balance calibrating method of the present invention. FIG. 2A is a perspective view showing that a fan impeller to be calibrated is placed on a balance calibration device of the first embodiment of the fan impeller balance calibrating method of the present invention. FIG. 2B is a bottom perspective view of the fan impeller. FIG. 2C is a perspective view showing the operation of the balance calibration device of the first embodiment of the fan impeller balance calibrating method of the present invention. FIG. 2D is a sectional view showing the operation of the balance calibration device of the first embodiment of the fan impeller balance calibrating method of the present invention. According to the first embodiment, the fan impeller balance calibrating method of the present invention is applied to a balance calibrating device 1 having a balance measurement unit 11. The fan impeller balance calibrating method of the present invention includes steps of:
S1: placing a fan impeller with multiple holes onto a calibrating platform of the balance measurement unit and activating the fan impeller to rotate, a fan impeller 2 being provided, in this embodiment, a bottom section 21 of the fan impeller 2 being formed with multiple holes 23, the fan impeller 2 being placed on a calibrating platform 12 of the balance measurement unit 11, the calibrating platform 12 serving to control and activate the fan impeller to rotate;
S2: using at least one detector of the balance measurement unit to detect the amount of unbalance and phase of the fan impeller in rotation and generate a detection signal according to the amount of unbalance and phase of the fan impeller, a detector 111 of the balance measurement unit 11 serving to detect the amount of unbalance and phase of the fan impeller 2 in rotation and generate a detection signal according to the amount of unbalance and phase of the fan impeller 2, the detector 111 being an accelerometer;
S3: providing a counterweighing unit, the counterweighing unit serving to receive the detection signal to find at least one hole of the fan impeller, which is to be counterweighed, the counterweighing unit then counterweighing the hole with a counterweight and determining the weight of the counterweight, a counterweighing 3 being provided, the counterweighing unit 3 serving to receive the detection signal to find the degree of balance of the fan impeller 2 according to the detection signal, then the counterweighing unit 3 counterweighing the hole 23 of the fan impeller 2, which is to be counterweighed, with a counterweight 31 and determining the weight and length of the counterweight 31 positioned in the hole 23, in this embodiment, the counterweight 31 being a solid;
S4: cutting the counterweight with a cutting unit to position the counterweight with the necessary weight in the hole after determining the weight of the counterweight, after the weight of the counterweight 31 is determined, a cutting unit 4 being attached to the bottom face 21 of the fan impeller 2 to cut the counterweight 31 so as to position the counterweight 31 with the necessary weight in the hole 23 and complete the counterweighing operation of the fan impeller 2;
S5: rotating the counterweighed fan impeller for the detector to detect whether the counterweighed fan impeller is balanced in rotation, if so, the procedure going to step S6, if not, the procedure going back to step S3, the counterweighed fan impeller 2 being again rotated by the balance measurement unit 11 and the detector 111 again detecting whether the counterweighed fan impeller 2 is balanced in rotation, if so, the procedure going to step S6, if not, the procedure going back to step S3; and
S6: taking off the counterweighed fan impeller, if it is detected that the counterweighed fan impeller 2 is balanced, then the calibration of the fan impeller 2 being completed, at this time, the balance measurement unit 11 automatically controlling the calibration platform 12 to stop rotating the counterweighed fan impeller 2, then the fan impeller 2 being taken off from the calibration platform 12.

According to the present invention, in manufacturing of the fan impeller 2, the measurement and counterweighing of the fan impeller 2 are automated. Accordingly, the fan impeller 2 can have better degree of balance. Moreover, the working time is shortened and the manufacturing cost is lowered. Also, the operation efficiency of the fan is increased.

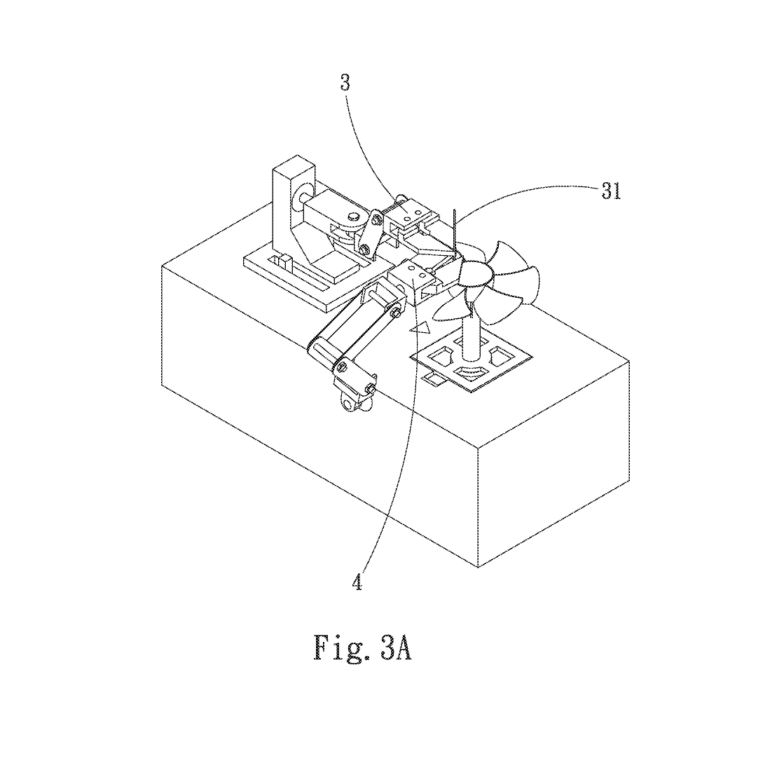

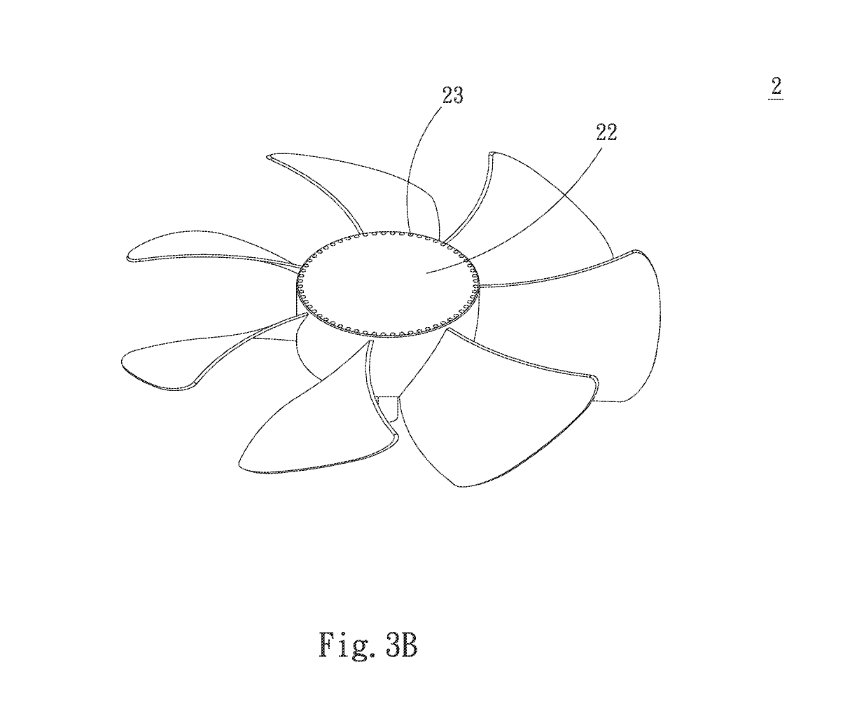

Please now refer to FIGS. 3A and 3B. FIG. 3A is a perspective view showing the operation of the balance calibration device of a second embodiment of the fan impeller balance calibrating method of the present invention. FIG. 3B is a top perspective view of a fan impeller to be calibrated. The second embodiment is partially identical to the first embodiment in step and thus will not be repeatedly described hereinafter. The second embodiment is different from the first embodiment in that the holes 23 are formed on a top section 22 of the fan impeller 2. The counterweighing unit 3 serves to counterweigh the hole 23 of the top section 22, which is to be counterweighed, with the counterweight 31 and determine the weight of the counterweight 31. The cutting unit 4 is attached to the top face 22 of the fan impeller 2 to cut the counterweight 31 so as to complete the counterweighing operation of the fan impeller 2.

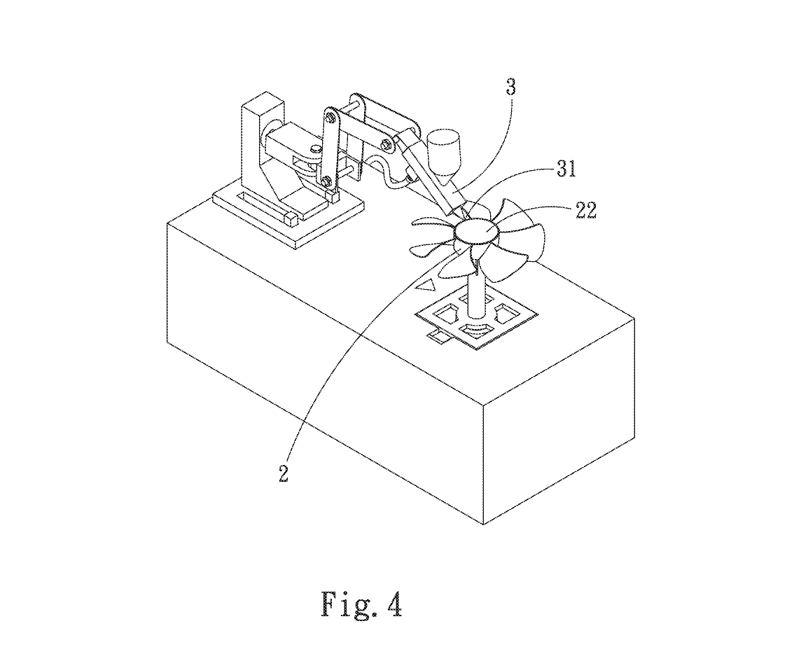

Please now refer to FIG. 4, which is a perspective view showing the operation of the balance calibration device of a third embodiment of the fan impeller balance calibrating method of the present invention. The third embodiment is partially identical to the second embodiment in step and thus will not be repeatedly described hereinafter. The third embodiment is different from the second embodiment in that the counterweight 31 is a glue material. The holes 23 are formed on a top section 22 of the fan impeller 2 (as shown in FIG. 3B). The counterweighing unit 3 serves to counterweigh the hole 23 of the top section 22, which is to be counterweighed, with the counterweight 31 and determine the weight of the counterweight 31 so as to complete the counterweighing operation of the fan impeller 2.

In conclusion, in comparison with the conventional technique, the present invention has the following advantages:
1. The manufacturing process is automated.
2. The working time is shortened and the manufacturing cost is lowered.
3. A better degree of balance is achieved.
4. The operation efficiency of the fan is increased.

The present invention has been described with the above embodiments thereof and it is understood that many changes and modifications in the above embodiments can be carried out without departing from the scope and the spirit of the invention that is intended to be limited only by the appended claims.

What is claimed is:

1. A fan impeller balance calibrating method applied to a balance calibrating device having a balance measurement unit, the fan impeller balance calibrating method comprising steps of:
placing a fan impeller with multiple holes onto a calibrating platform of the balance measurement unit and activating the fan impeller to rotate;
using at least one detector of the balance measurement unit to detect the amount of unbalance and phase of the fan impeller in rotation and generate a detection signal according to the amount of unbalance and phase of the fan impeller; and
providing a counterweighing unit, the counterweighing unit serving to receive the detection signal to find at least one hole of the fan impeller according to the detection signal, which is to be counterweighed, the counterweighing unit then counterweighing the hole with a counterweight and determining the weight of the counterweight.

2. The fan impeller balance calibrating method as claimed in claim 1, wherein after determining the weight of the counterweight, the counterweight is cut with a cutting unit to position the counterweight with the necessary weight in the hole.

3. The fan impeller balance calibrating method as claimed in claim 2, wherein the counterweight is a solid.

4. The fan impeller balance calibrating method as claimed in claim 2, wherein the counterweight is a glue material.

5. The fan impeller balance calibrating method as claimed in claim 2, further comprising a step of rotating the counterweighed fan impeller for the detector to detect whether the counterweighed fan impeller is balanced in rotation after the counterweight is cut with the cutting unit to position the counterweight with the necessary weight in the hole, if the counterweighed fan impeller is balanced, the counterweighed fan impeller being taken off.

6. The fan impeller balance calibrating method as claimed in claim 5, wherein if the counterweighed fan impeller is still not balanced, the counterweighing unit is again used to receive the detection signal and determine the weight of the counterweight according to the detection signal and after determining the weight of the counterweight, the counterweight is again cut with the cutting unit to position the counterweight with the necessary weight in the hole.

7. The fan impeller balance calibrating method as claimed in claim 1, wherein the fan impeller has a top section and a bottom section, the holes being formed on the top section or the bottom section of the fan impeller.

8. The fan impeller balance calibrating method as claimed in claim 1, wherein the detector is an accelerometer.
